(19) United States
(12) Patent Application Publication
(10) Pub. No.: US 2009/0144135 A1
(43) Pub. Date: Jun. 4, 2009

(54) Methods for the management and protection of electoral processes, which are associated with an electronic voting terminal, and operative module used

(76) Inventors: Andreu Riera Jorba, Santpedor (ES); Jordi Puiggali Allepuz, Sant Cugat del Valles (ES)

Correspondence Address: RATNERPRESTIA, P.O. BOX 980, VALLEY FORGE, PA, 19482, US

(21) Appl. No.: 11/658,232

(22) PCT Filed: Jul. 27, 2004
(86) PCT No.: PCT/ES04/00350

§ 371 Date: Oct. 31, 2008

(51) Int. Cl. G06F 11/00

(52) U.S. Cl. 705/12

(57) ABSTRACT

The inventive method is characterised in that, following a voting option selection step (201), a verification module (102), which is associated with a voting terminal (101), is used to perform the following steps: reception (202) of digital data relating to the voting options selected by a voter (103) at the voting terminal (101); verification (203) of the options selected by the voter (103), which are in some way encoded in the data received during the preceding step; confirmation (204) by the voter (103) of the voting options presented during the previous step; and, upon acceptance of said voting options by the voter (103), generation of a digital record to protect the integrity of the digital data received during the above-mentioned data-reception step.

### FIELD OF THE INVENTION

The present invention relates to a method for the management and protection of electoral processes which is implemented in association with an electronic voting terminal, i.e. starting from the digital data coming from said voting terminal. Said method comprises an interface for presenting the voting options to be selected as well as interactive means for carrying out said selection. After selecting the vote, the latter can be sent to a remote site where it is processed.

The invention also relates to a verification operative module connected to a computerized voting terminal which allows carrying out the operations of the proposed method.

### BACKGROUND OF THE INVENTION

In an electronic voting method, a voter or a plurality of them cast their votes from a voting terminal. In said terminal the voters carry out all or part of the processes for selecting the voting options, verifying that said selected options are the desired ones, casting the vote (after confirmation) and, depending on the type of voting terminal, storing the votes and subsequently counting them. Both the security of these terminals and the correct operation thereof are critical for the development of an electoral process, therefore it is essential for said terminals to incorporate security and audit measures facilitating the verification of their correct operation.

Electronic voting machines were introduced in the United States in the 70s (U.S. Pat. No. 3,934,793) as a similar but more sophisticated version of the voting terminals based on the use of levers (voting lever machines). In this electronic voting machines, the voter selects his/her voting options and depending on the equipment used by the voting machine, he/she casts his/her vote or opinion by means of pressing a button or pressing a touch screen. As occurs in traditional elections, the voters go to the voting place corresponding to their electoral district and prove that they are authorized to cast their vote in said place, generally by mean of presenting a document proving their identity. After this process, the voter casts his/her vote in the voting terminal.

It will be observed that this type of electronic voting systems must incorporate a series of security measures. Voting by means of using physical ballots in conveniently sealed transparent ballot boxes is carried out with confidence due to the use of physical security measures which allow visually corroborating that the envelope containing the vote has been effectively and anonymously collected together with the rest of the votes, therefore it will form part of the subsequent counting process. Nevertheless, this type of physical protection means is not useful in systems using electronic voting terminals.

Most of the electronic voting terminals existing on the market are complex devices, a combination of hardware and software architecture, and are usually protected by intellectual property rights or include components (e.g. software) which are subject to these rights. All this causes a great opacity with respect to how the electoral process is carried out by the voting terminals and therefore, it increases the concerns on the possibility of a manipulation of the votes cast on the voting terminal. Furthermore, the audit processes intended to verify the compliance of the necessary requirements to ensure the security of an election and detect possible fraudulent practices are expensive and not transparent. In fact, this audit process is usually carried out by independent laboratories which must agree on very strict confidentiality contracts. These are the main reasons for which there are still a large number of sceptics with respect to the use of said electronic voting methods.

The so-called DRE (Direct Recording Electronic) is one of electronic voting terminals which have recently caused more controversy. In fact, in July 2003, researchers of the John Hopkins and Rice universities published a report (Khono T., Stubblefield A. and Rubin A. Analysis of an Electronic Voting System. Johns Hopkins Information Security Institute Technical Report TR-2003-19) which casts a doubt on the security of one of the major manufacturers of DRE, Diebold. In spite of the answers made by experts of the company, there are still some aspects to be clarified which do not allow assuring the complete security of their terminals.

It must be taken into account that the more complex the voting terminal to be audited is, the time and economic cost increases to limits that are sometimes non viable. Considering that these terminals could be changed and/or updated (software reviews, substitution of failed components etc.) during their life cycle, the problem increases since each change involves a new review of each and every one of the terminals which have been subjected to the change.

For the main purpose of reducing the lack of confidence in current voting terminals, security measures allowing the voter to verify if the vote registered electronically corresponds to his/her voting intention have been proposed recently. The measures proposed to date can be summarized in those based on printing the votes to allow a manual counting, and those based on cryptographic schemes or protocols to provide the voter with certain cryptographic information linked to the vote which will allow the voter to later verify if his/her vote has been registered correctly.

The measures based on the printing of paper votes (Mercury, R. Facts About Voter Verified Paper Ballots) allow the voter to verify his/her vote before it is cast and, if required, these paper votes can be used later to audit the fairness of the process. This audit process is commonly called voting terminal results verification. Said verification ensures the accuracy of the electoral process to a great extent, however it has the drawback that it is quite expensive since requires a lot of time for the manual review of the votes. Furthermore this process is high vulnerable to failures of the used mechanical components (such as printers) and human errors or fraud. For the purpose of speeding up the counting process, several voting terminals, such as Accupoll Inc. terminals which use special codes or inks at the time of printing the vote, have been proposed. These kind of terminals introduced improvements, however they still do not provide a completely reliable solution for fraud issues. They further add a new complexity factor to the audit because the correctness of the counting devices must also be verified.

Voting terminal cryptographic schemes or protocols for vote verification, such as those described in (EP-B1-1 224 767, WO-A3-02/077754, WO-A2-03/071491, WO-A1-03/050771), ensure the fairness of the electoral process by means of generating an authentication proof or receipt allowing the voter to verify the accuracy of the whole process. Even so, the use of these protocols in voting terminals does not reduce the complexity of the audit, since the implementation of these protocols and the environment in which they are executed (which is normally the terminal itself) must be audited to verify that the protocols have been correctly implemented.

In 2001, Bruck and other investigators (Bruck S., Jefferson D. and Rivest R. A modular voting architecture (“Frogs”), WOTE minutes, August 2001) proposed a new approach for simplifying the voting terminal audit process based on the use of a modular architecture in voting systems. This proposal introduces the use of a specific terminal for displaying the vote stored in a memory device (e.g. a card). This vote, which has been previously generated in an independent manner from a voting terminal, is recorded in a memory device, and this memory device is deposited in a physical ballot box like a traditional paper vote. The main advantage of this system lies in the fact that the voting terminal does not need to be audited. On the other hand, it has the drawback that it cannot be used for the casting of remote votes, nor it does allow the verification of the results of an election without having to store all the used memory devices with cast votes. Therefore the counting involves reading each and every one of the memory devices. Furthermore, the mentioned approach does not provide supplementary measures, such as voting receipts, to facilitate the voter verification of the election results.

Therefore, there is an evident need to introduce a new method providing effective verification means to the voters while facilitating a voting terminal audit process at the same time.

### BRIEF DESCRIPTION OF THE INVENTION

The present invention describes a method for the management and protection of electoral processes which are carried out by electronic voting terminals. The invention also relates to the specifications of an operative module which, associated with a voting terminal, allows implementing said method.

To that end, a first objective of the present invention is to define a method for implementing a secure environment which can be easily audited and is associated with a voting terminal, and which allows ensuring the correct operation of an election independently of the security of the voting terminal to which it is associated.

It is another objective of the present invention the protection of the privacy and integrity of the electronic votes once they have been cast from said environment. In this way, said votes can be securely processed by third parties.

For the purpose of offering voters the possibility of verifying that their votes have been correctly and electronically registered, the present invention also introduces a verification step with these properties.

Another objective of the invention is to provide an audit mechanism for auditing the results of a simple election, based on digital measures.

Finally, but not less importantly, an objective of the present invention is to allow the implementation both in person and remote electronic voting environments.

The proposed method is characterised by comprising the following basic steps: receiving digital data relating to the voting options selected by a voter; providing an interface so that the voter can verify the previously selected voting options which can be selected; providing means for the voter to confirm the verified options; and, in the event that said voting options are accepted, generating a digital record which protects the integrity of said digital data.

The method can further comprise an additional step of sending to the associated voting terminal digital data containing at least the result of said confirmation and more specifically containing digital information relating to said one or more selected voting option/options.

The proposed method allows carrying out an audit of the electoral process started in said voting terminal, by means of auditing the mentioned verification module.

In its basic version, the operative or verification module used for implementing the proposed method comprises the following elements: an input unit enabling the interaction with said voting terminal to receive the digital data related to the voting option/options selected in said voting terminal; an interface for the voter to verify said previously selected voting option/options; confirmation means; and a processing unit generating a digital record to protect the integrity of all the previously and subsequently confirmed digital data.

In a preferred embodiment, said verification module further comprises an output unit for sending digital data resulting from the verification process.

Other features of the invention and, more specifically, specific features of the steps of the method and the elements forming the verification module will be described with more detail below, including some drawings.

### BRIEF DESCRIPTION OF THE DRAWINGS

FIG. 1 shows the main implementation elements on which the electronic voting method described in the present invention: a voting terminal (101) through which the voter (103) selects the voting options and a verification module (102) allowing the voter (103) to verify the voting options which he/she has selected in the voting terminal (101).

FIG. 2 shows the main steps characterizing the proposed voting method. After carrying out the selection (201) of the voting option/options in the voting terminal (101), the verification module (102) receives (202) digital data relating to said selected voting option/options. Then, the voter (103) verifies (203) the selected voting option/options and confirms, if he/she agrees with these options, the selection of his/her vote by a suitable confirmation means (at least a pair of buttons of the verification module in FIG. 2). Finally, after confirming that the vote has been digitally recorded, the vote is cast (205).

FIGS. 3a, 3b, 3c, 3d and 3e describe each one of the previous steps with more detail. In FIG. 3a, the digital data containing the selection (301) of the voting option/options is received in the verification module (102), in which the verification process (302) takes place. The verification (302) of each of the previously selected voting option/options will be carried out through a suitable interface, which in FIG. 3b is a visual interface (303) or an audible interface (304). In FIG. 3c the vote selection (201) is confirmed (204) (in the event that the verification process has been carried out satisfactorily), by means of a pair of buttons (305) forming part of the verification module (102). The vote casting (306) is described in FIG. 3d, whereas finally, FIG. 3e shows the generation of a digital record (307) which protects the integrity of said digital data.

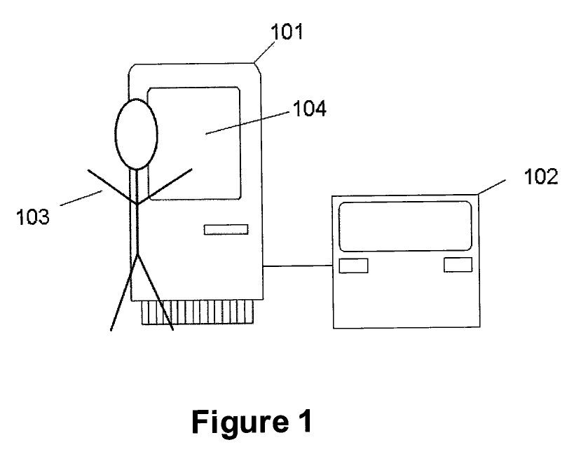

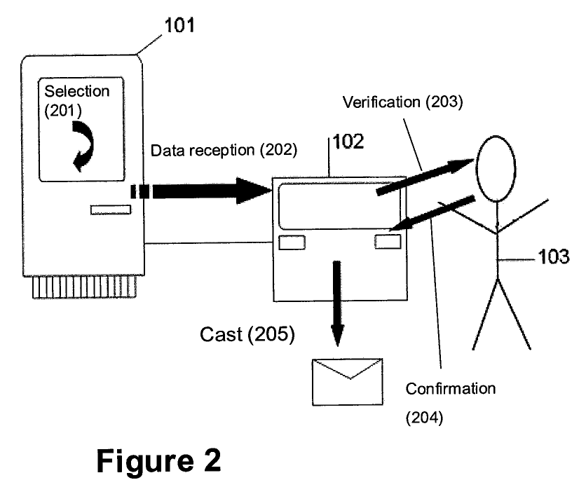

### DETAILED DESCRIPTION OF THE INVENTION

The present invention relates to a method for the management and protection of electoral processes using electronic voting terminals 101 as a platform for capturing the voting preferences of the voters 103 and casting the votes. The use of a verification module 102 associated with an electronic voting terminal 101, with a well-known structure and functionality, is proposed to put said invention into practice. In addition to providing substantial improvements in the security of the electoral process, said module 102 also facilitates and even simplifies the audit of said electoral processes.

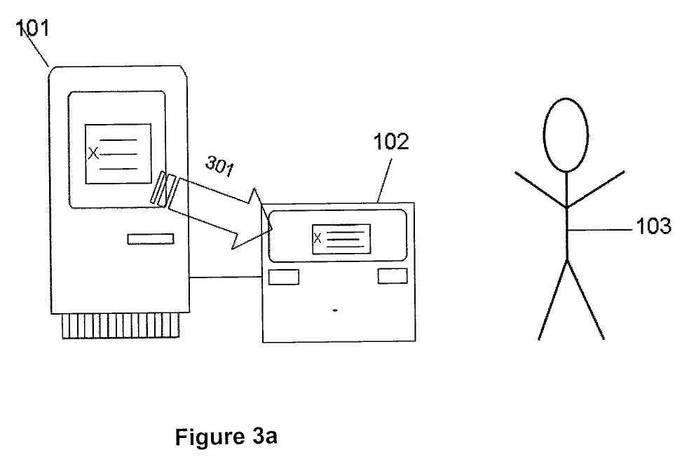

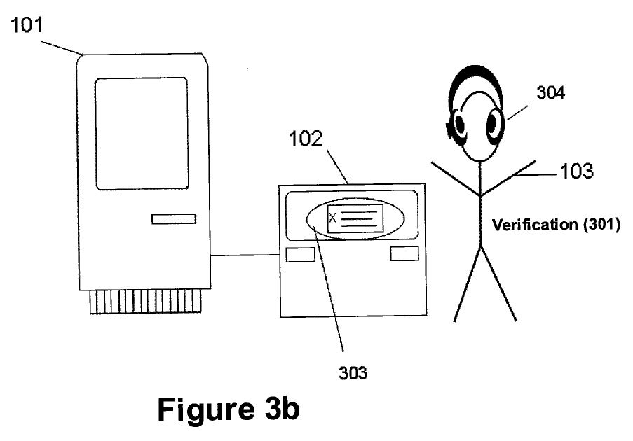

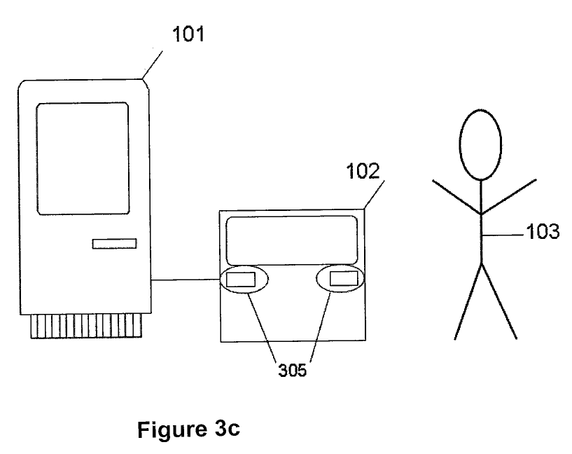

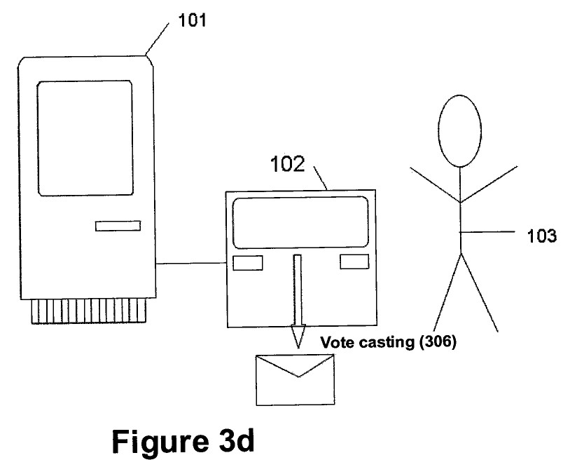

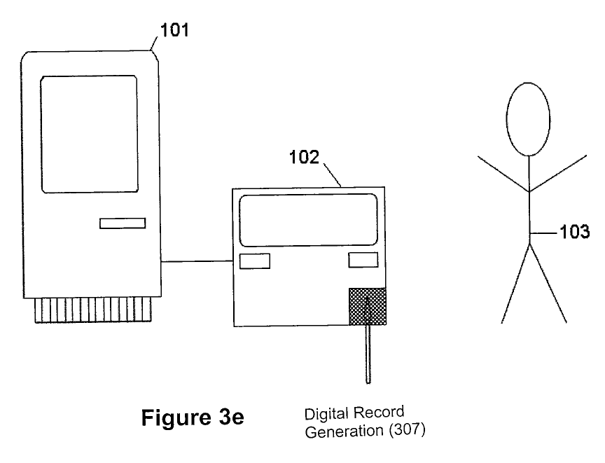

According to the present invention, the verification module 102 comprises the next elements. An input unit that allows receiving data, in digital format, related to the voting options selected in the voting terminal 101 associated with this module. An interface 303 and 304 (FIG. 3b) allowing the voter 103 to verify the voting options relating the data received by the input unit. Confirmation means 305 which will allow the voter to confirm if the options presented in the interface are the desired ones. And finally, if the voter has confirmed the options, a processing unit executing the processes of generating a digital record 307 (FIG. 3e) that protects the integrity of the data which has been received by the input unit.

In a preferred embodiment, verification module 102 also incorporates an output unit for sending outside the module certain digital data obtained as the result of the verification process 302 carried out therein. In order to facilitate the interconnectivity of the verification module 102 with the voting terminal 101, said input unit and said output unit can be the same unit. Therefore, the same communication channel could be used for sending and receiving data, such as a single data communication cable.

A storage unit (such as a write-once device) can be also associated with the verification module 102 to store the data needed for the generation of the mentioned digital record 307. Due to the fact that the stored data can be necessary during the election, this storage unit can be persistent to prevent the loss of data due to a power failure.

To facilitate the integration with a voting terminal 101, this device can have an autonomous power supply source. In this way, it can obtain the energy for its operation from its own power supply. It could be possible to consider that said energy is obtained from the voting terminal 102 to which it is associated.

The method for the management and protection of electoral processes of the present invention is implemented, as explained previously, in association with a voting terminal 101. The voting terminal 101 essentially must have at least one interface 104 for presenting the voting options to be selected, and means with which a voter 103 interacts for selecting one or more voting options and therefore carry out said selection 201. After said step, the selected voting options are provided to a local or remote processing site for their counting.

The mentioned method is essentially characterised in that after the voting option selection step 201, it comprises carrying out the following steps by means of the verification module 102 associated with said voting terminal 101:
reception 202 of digital data related to the voting options selected by a voter 103 at the voting terminal 101;
verification 203 of the voting options selected by the voter 103 which are in some way encoded within the digital data received during the preceding step. The method contemplates the implementation of an interface 303 and 304 for facilitating to the voter 103 the verification 302 of said selected voting options;
confirmation 204 by the voter 103 of the voting options presented during the previous verification step. For this confirmation, the method provides the voter 103 with a confirmation means 305; and
finally, in the event that the voter 103 has accepted the voting options in the previous confirmation step, the generation of a digital record 307 which protects the integrity of the digital data which has been received in the reception step.

The method takes into account that the received data 301 comprises at least the options selected by the voter 103 at the voting terminal 101, allowing the inclusion of other additional data which could be useful for auditing, such as specific information of the election.

To facilitate the accessibility of disabled voters 103, the verification process 302 supports different interfaces for presenting the received voting options 301. For this purpose, said interface can be a visual 303, audio 304 or touch interface (not graphically shown but which can be implemented by means of a Braille device).

With reference to the previously described verification module 102, different embodiments can be implemented according to said interfaces, such as video screen (such as an LCD screen) or a printer if it is a visual interface. If it is an auditory interface, of the embodiment implements an audio device, such as earphones. Another additional embodiment implement an interface based on a touch device, such as Braille character generating device.

For the confirmation step, the method described in the present invention supports confirmation means that allow the voter 103 to choose between at least two options, such as the acceptance or rejection of the options presented in the verification step 203. Although the voter had two or more different options to confirm it is not required to have one interface component for each option (for example, a different button per option). Therefore, there can be a default option which is automatically executed in the event that certain conditions are complied with, such as after an established inactivity time. To facilitate the accessibility of the voters, the options can be implemented by: two buttons of said interface (which can be substituted by a single button when using a certain pushing sequence) or, in an alternative embodiment based on an audio interface, they could be a minimum of two audible commands (which can be introduced through a microphone for example).

These interfaces are implemented in the verification module 102 by means of a touch device, such as a button or by using a screen, or an audio device such as microphone, which will allow colleting voice commands for their interpretation.

According to a preferred embodiment, the method comprises an additional step (known as sending step) for sending to said voting terminal 101 some digital data containing at least the result of said voter confirmation made in said verification module 102. Said confirmation digital data can additionally contain digital information relating to the selected voting options. Therefore, the confirmed voting options can be stored in the voting terminal 101 itself or even in another machine, allowing the use of this method in remote electronic voting environments, where the votes are stored remotely.

In a preferred embodiment of this method, an audit of the whole electoral process associated with said voting terminal 101 is implemented through a single audit of said verification module 102. The data stored in the digital record 307 can supports different security and audit levels, depending on the requirements of the election.

For verifying the integrity of the results obtained from the voting options selected in the voting terminal 101, the method can use the digital record 307 generated by the verification module 102. In a preferred embodiment, said digital record 307 is stored in said verification module 102, allowing its access when auditing said module. Said digital record is a key part for the security of the electoral process. Different approaches for implementing the digital record method are considered in this invention, each of them complying with different security requirements.

In a first approach, this method considers a set of implementations which do not incorporate security cryptographic means. However they do detect possible manipulations of the cast votes. To that end, said digital record 307 can comprise a copy of said received and confirmed digital data, a process which would be equivalent to having an independent copy of the voting options selected at a voting terminal 101 but confirmed in their associated verification module 102. As an additional measure, this digital record with a copy of the voting options can be complemented with a counter registering the number of confirmations carried out for each of the different voting options. As a simplified alternative, the digital record can only comprise the counter with the number of confirmations carried out for each of the different possible voting options, without the copy of the selected voting options.

In a second approach, and according to a preferred embodiment of the method proposed in the present invention, the step of generating a digital record 307 comprises carrying out a cryptographic operation on at least part of said received digital data from the voting terminal 101. This measure allows improving the implementation of the measures of the first group and even increasing the security of the electoral process in some implementations.

A first proposal of cryptographic operation for generating a digital record consists on executing a hash function, such as an accumulation summary function (OWA), of the contents of all the accumulated digital data received until that time from the voting terminal 101 that have been confirmed by the voters. This measure allows verifying the integrity of the cast votes without needing to keep a copy of all of them, therefore the space requirements are lower since do not depend on the number of cast votes. This proposal can be complemented by adding to the digital record the number of confirmations of each of the different voting options.

A second proposal is based on the use of asymmetric keys for the protection of the confirmed voting options. This proposal is mainly designed to protect the voting options when sent outside the verification module 102. As a first measure, the verification module 102 is provided with at least one asymmetric key to protect by means of digital signatures the integrity of the content of the digital record 307. Thus, in a preferred embodiment, the digital record 307 comprises at least one digital signature generated from the digital data 301 of the reception step using the private component of said at least one pair of asymmetric keys. An alternative method based on protecting the privacy of the digital record comprises an encryption (such as a digital envelope) of said digital data 301 of the reception step using said at least one public key of an authority. This measure only allows the authority on possessing of the private key to access the contents of the digital record. In addition, said digital record will have an associated digital signature for said encryption. This digital signature can be generated with the private component of said at least one pair of asymmetric keys of the verification module. In this way, both the privacy of the content and the integrity thereof are ensured. When the privacy of the content of the digital record (e.g. with digital envelopes) is protected by means of the encryption, the method considers an additional step for deciphering said digital data, by means of using at least one private key of an authority.

Finally, the method also provides measures for enabling the voter verification of the elections.

A first measure allows the voter 103 to verify himself/herself the accuracy of the voting process associated with the voting terminal 101 by means of implementing an additional step of issuing a voting receipt to the voter based on a single identifier. For this purpose, the operative module 102 can incorporate a unit for issuing a voting receipt to the voter 103.

In the event that the votes cast are printed (e.g. as a verification measure), the method can implement an additional step of incorporating to the printed vote cast a graphic representation of said digital signature of the content representing said digital data 301 of the reception step, with the purpose of adding an integrity proof to said printed votes.

This invention also provides means for facilitating an audit of the verification module 102. In this sense, the processing unit of the verification module 102 can be in a removable media with computation ability, such as a smart card. In order to increase the security of the module, said removable device can integrate cryptographic functionalities, such as the management and generation of asymmetric keys, the digital signature or the symmetric encryption. In this way, the cryptographic operations are implemented in an isolated environment protected against external attacks. Finally, the audit could be facilitated if said removable device integrates at least one storage unit, such as an internal memory, in which the digital record could be stored.

1. A method for the management and protection of electoral processes associated with an electronic voting terminal, and said voting terminal comprising at least one interface for presenting the voting options to be selected, and means for carrying out a selection step in which a voter selects one or more voting options, after which step one or more selected voting options is/are provided to a local or external processing module, characterised in that after said selection step, it comprises the following steps implemented by means of a verification module associated with said voting terminal:
a) receiving digital data relating to said one or more selected voting option/options;
b) providing an interface in which the voter can verify said one or more previously selected voting option/options;
c) providing confirmation means; and
d) in the event that said one or more voting options have been accepted by said voter generating by means of said confirmation means a digital record to protect the integrity of said digital data.

2. A method, according to claim 1, further comprising sending informative digital data containing at least the result of said confirmation.

3. A method, according to claim 2, wherein said sending step is carried out towards said voting terminal.

4. A method, according to claim 2, wherein said informative data contain digital information relating to said one or more selected voting option/options.

5. A method, according to claim 1, wherein said digital data of step a) comprises at least said one or more options selected by the voter at the voting terminal.

6. A method, according to claim 1, wherein said digital record can be used to verify the integrity of the counting results of the voting option/options selected at the voting terminal associated with said verification module.

7. A method according to claim 1, further comprising carrying out an additional step consisting of an audit of the electoral process associated with said voting terminal through an audit of said verification module.

8. A method according to claim 1, wherein said step b) comprises providing a visual interface.

9. A method according to claim 1, wherein said step b) comprises providing an audio interface.

10. A method according to claim 1, wherein said step b) comprises providing a touch interface.

11. A method according to claim 1, wherein said step b) comprises providing an interface with at least two options.

12. A method according to claim 11, wherein said options are represented by at least two buttons of said interface.

13. A method according to claim 11, wherein said options respond to a minimum of two audio commands audible through said interface.

14. A method according to claim 1, wherein said step d) for generating a record comprises the generation of a copy of said received and confirmed digital data.

15. A method according to claim 14, wherein said step d) for generating a record further comprises using a counter for counting the accumulated number of voting options of the confirmed digital data.

16. A method according to claim 1, wherein said step d) for generating a record comprises using a counter for counting the accumulated number of voting options of the confirmed digital data.

17. A method according to claim 1, wherein said step d) for generating a record comprises carrying out a cryptographic operation on at least a part of each of said digital data confirmed and received from the voting terminal.

18. A method according to claim 17, wherein the result of said cryptographic operation comprises a digest based on the exact contents of each and every one of the received and confirmed digital data.

19. A method according to claim 18, wherein said cryptographic operation is an accumulation hash function (OWA).

20. A method according to claim 18, wherein said step d) for generating a record comprises using a counter for counting the accumulated number of voting options of the confirmed digital data.

21. A method according to claim 15, wherein said record is stored in said verification module.

22. A method according to claim 17, further comprising providing the verification module with at least one asymmetric key.

23. A method according to claim 22, wherein said digital record comprises a digital signature based on data from said digital data of step a), using the private component of said asymmetric keys which are at least one in number.

24. A method according to claim 22, wherein said digital record comprises an encryption based on said digital data of step a), using at least one public key of an authority.

25. A method according to claim 24, wherein said encryption consists on a digital envelope.

26. A method according to claim 24, wherein said digital record has an associated digital signature generated with the private component of said asymmetric keys which are at least one in number.

27. A method according to claim 24, further comprising an additional step for deciphering said encrypted digital data using at least one private key of an authority.

28. A method according to claim 24, further comprising an additional step for issuing a voting receipt based on a single identifier to the voter.

29. A method according to claim 23, further comprising an additional step of adding a graphic representation of said digital signature to a printed representation of said digital data of step a).

30. A verification module associated with an electronic voting terminal, said voting terminal comprising at least one interface for presenting the voting options to be selected and means with which a voter interacts to carry out a selection step for selecting one or more voting options, after which one or more selected voting options are provided to a local or remote processing site, said verification module comprising:
a) an input unit allowing the interaction with said voting terminal to receive digital data relating to the voting option/options selected at said voting terminal;
b) an interface for the voter to verify said previously selected voting options;
c) confirmation means; and
d) a processing unit for generating a digital record to protect the integrity of all the digital data received in section a) and which have been confirmed by means c).

31. A verification module according to claim 30, further comprising an output unit for sending digital data resulting from the verification process.

32. A verification module according to claim 31, wherein said digital data resulting from the verification process is sent to said voting terminal.

33. A verification module according to claim 31, wherein said input unit and said output unit are the same unit.

34. A verification module according to claim 30, further comprising a storage unit for storing necessary data for the generation of said digital record described in section d).

35. A verification module according to claim 34, wherein said storage unit is a write-once device.

36. A verification module according to claim 30, further comprising a unit for issuing a voting receipt to the voter.

37. A verification module according to claim 30, wherein said verification interface is a video screen selected from the group comprising at least one LCD screen or one TFT screen.

38. A verification module according to claim 30, wherein said verification interface is an audio device selected from the group comprising at least earphones or loudspeakers.

39. A verification module according to claim 30, wherein said verification interface is a printer.

40. A verification module according to claim 30, wherein said verification interface is a touch device selected from the group comprising at least one character recognition device or a Braille display.

41. A verification module according to claim 30, wherein said confirmation means are a touch device selected from the group consisting of at least one button or one screen.

42. A verification module according to claim 30, wherein said confirmation means are an audio device selected from the group consisting of at least a sound recorder or detector, or a microphone.

43. A verification module according to claim 30, wherein said processing unit is in a removable device with computation means, selected from the group consisting of at least a smart card or one FPGA.

44. A verification module according to claim 43, wherein said removable device has cryptographic functionalities comprising at least one management and generation of asymmetric keys, digital signature or symmetric encryption.

45. A verification module according to claim 43, wherein said removable device integrates at least one storage unit selected from the group comprising a RAM memory, a flash memory or an internal memory.

46. A method, according to claim 3, wherein said informative data contain digital information relating to said one or more selected voting option/options.

47. A method according to claim 16, wherein said record is stored in said verification module.

48. A method according to claim 20, wherein said record is stored in said verification module.

49. A method according to claim 26, further comprising an additional step of adding a graphic representation of said digital signature to a printed representation of said digital data of step a).
